(19) United States
(12) Patent Application Publication
(10) Pub. No.: US 2012/0266504 A1
(43) Pub. Date: Oct. 25, 2012

(54) Pop-Up Greeting Card

(76) Inventor: Irving R. Michlin, Murrieta, CA (US)

(21) Appl. No.: 13/455,540

(22) Filed: Apr. 25, 2012

Related U.S. Application Data
(60) Provisional application No. 61/517,750, filed on Apr. 25, 2011.

(51) Int. Cl. G09F 1/06; B32B 3/24; B32B 3/02

(52) U.S. Cl. 40/124.08; 428/138; 428/42.2

(57) ABSTRACT

The one piece blank for forming the pop-up greeting card has a pair of mutually perpendicular fold lines dividing the blank into four equal sections. One section has a die-cut area for forming a pop-up flap having a main section for imaging of a message thereon. A support section of the flap and a pair of hinge sections opposite sides of said support section hold the main section is spaced parallel relation to the upper section of the card when the card is opened.

This application claims the benefit of Provisional Application 61/517,750 filed Apr. 25, 2011.

This invention relates to a blank for making a Pop-up greeting card and to a greeting card made thereby.

As is known, a conventional type of greeting card is constructed from a one piece blank that is generally folded in half along a horizontal line and then folded in half again along a vertical line. In other types of greeting cards, various panels are provided to present a “pop-up” that projects out of the plane of the card when opened by a recipient.

It is an object of the invention to provide a blank for making a greeting card that produces a pop-up in an integrated manner upon opening of the greeting card.

It is another object of the invention to provide a greeting card with a pop-up flap that is integrated to pop-up upon opening of the greeting card.

It is another object of the invention to provide a blank for making a pop-up greeting card that is of economical construction and one which can be easily fabricated into a pop-up greeting card.

It is another object of the invention to provide a blank for making a pop-up greeting card that can be provided with customized information for a recipient.

Briefly, the invention provides a blank that may be folded in quarters to form a greeting card and that includes an integral pop-up flap that can be positioned outwardly of the card when the card is opened.

The blank provided by the invention provides a simple structure from which a Pop-up greeting card can be economically fabricated. Also, the greeting card provided by the invention presents a novel manner of presenting information to a recipient in an aesthetically pleasing manner.

These and other objects and advantages of the invention will become more apparent from the following detailed description taken in conjunction with the accompanying drawings wherein:

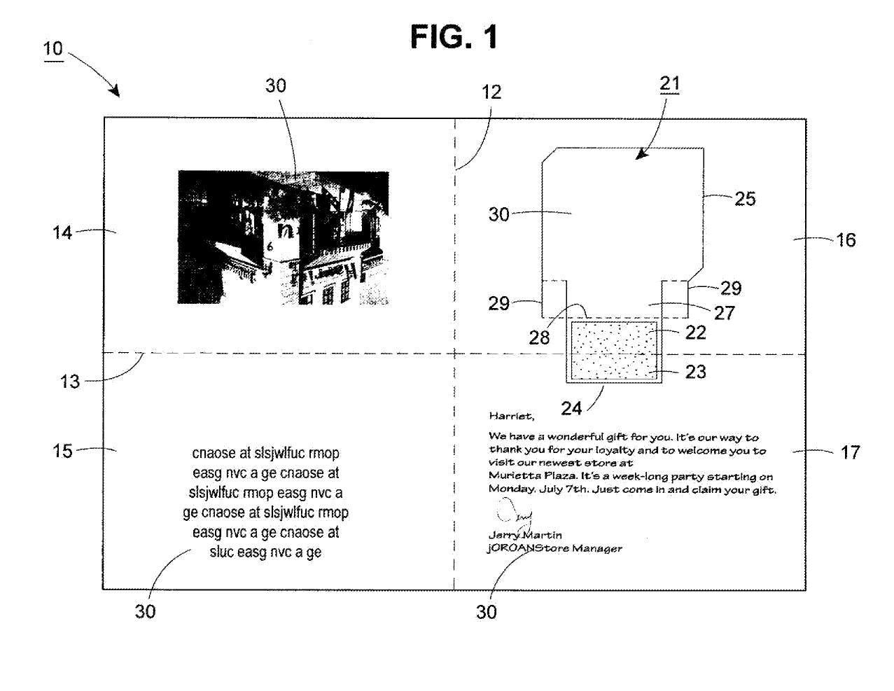

FIG. 1 illustrates a view of a front face of a blank for making the pop-up greeting card in accordance with the invention;

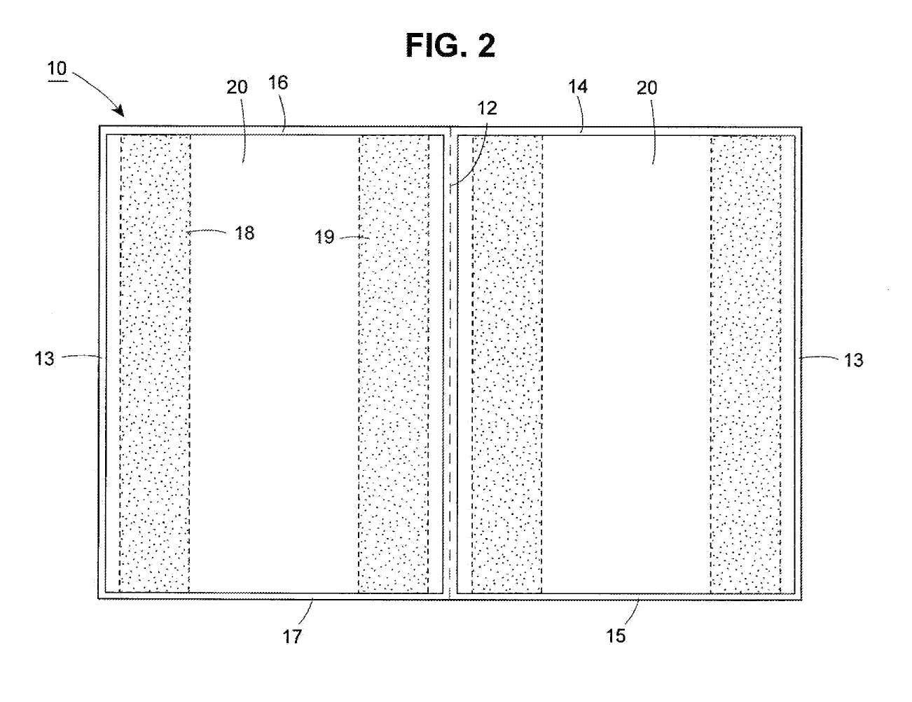

FIG. 2 illustrates a back view of the blank of FIG. 1;

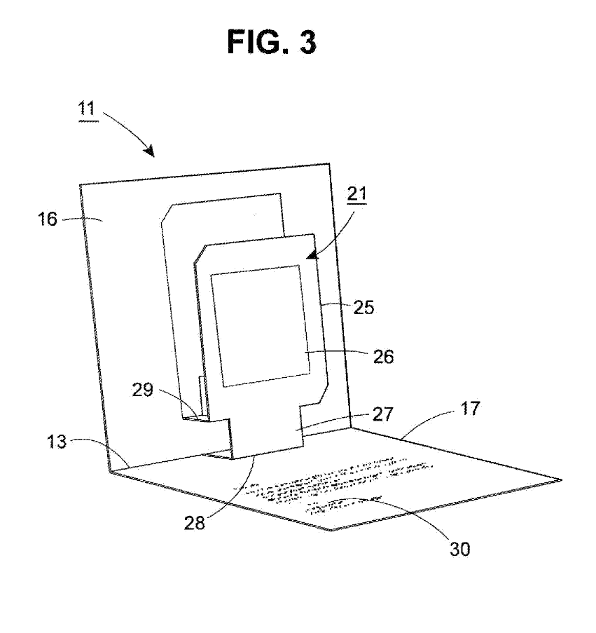

FIG. 3 illustrates a perspective view of an opened greeting card made from the blank of FIG. 1;

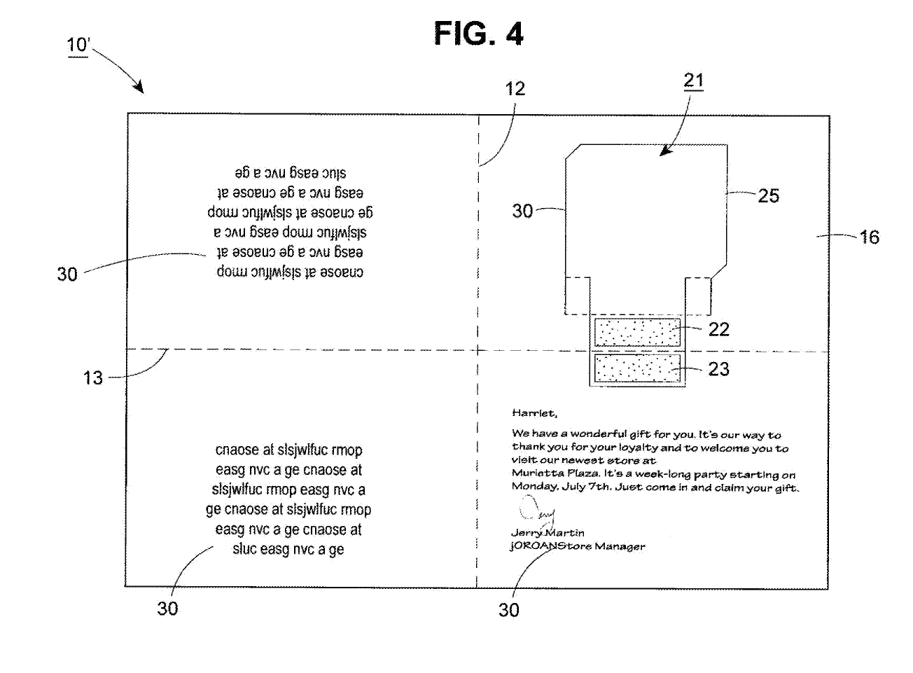

FIG. 4 illustrates a view of a front face of a modified blank for making the pop-up greeting card in accordance with the invention;

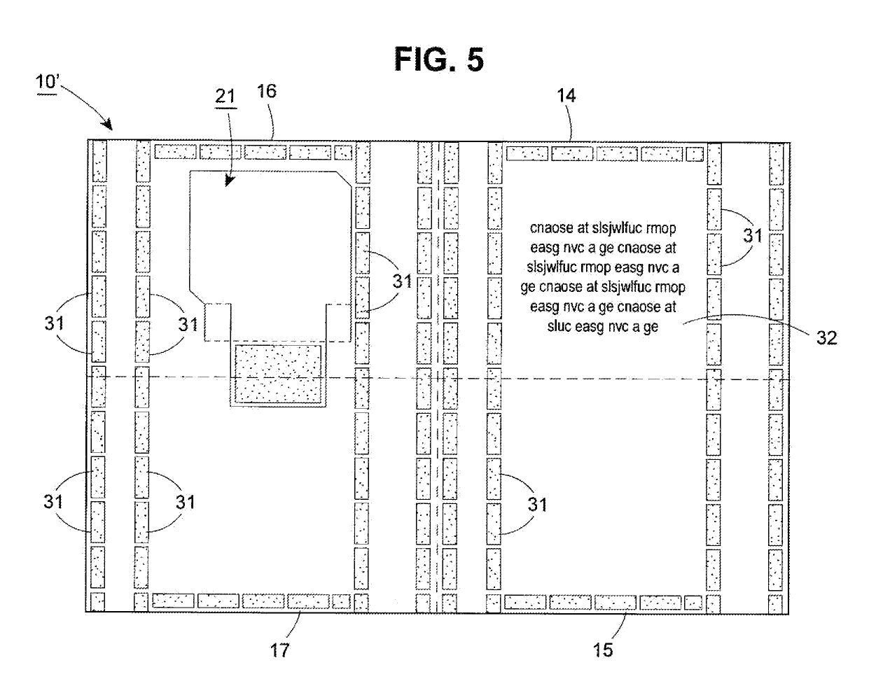

FIG. 5 illustrates a back view of the blank of FIG. 4;

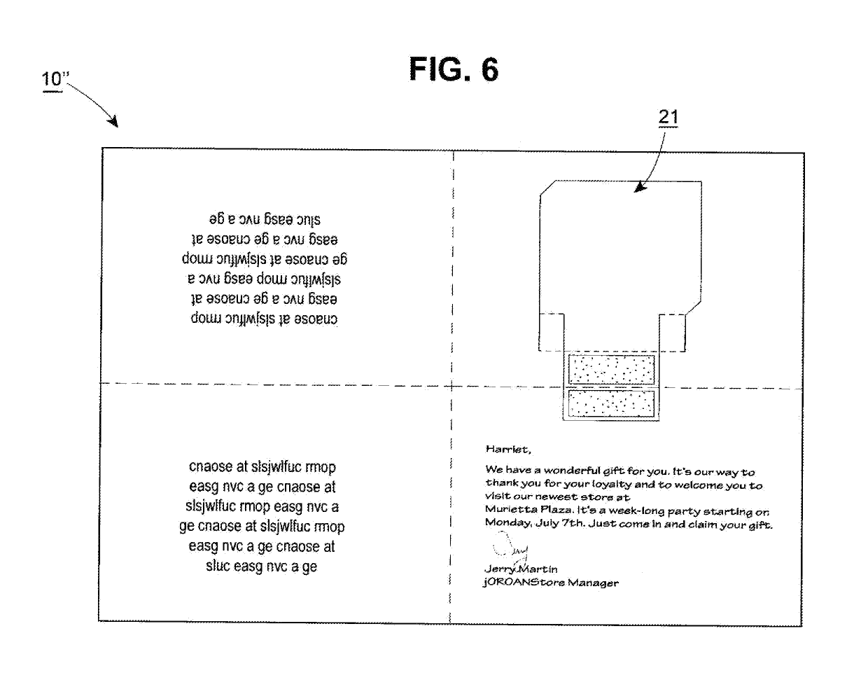

FIG. 6 illustrates a view of a front face of a further modified blank for making the pop-up greeting card in accordance with the invention; and

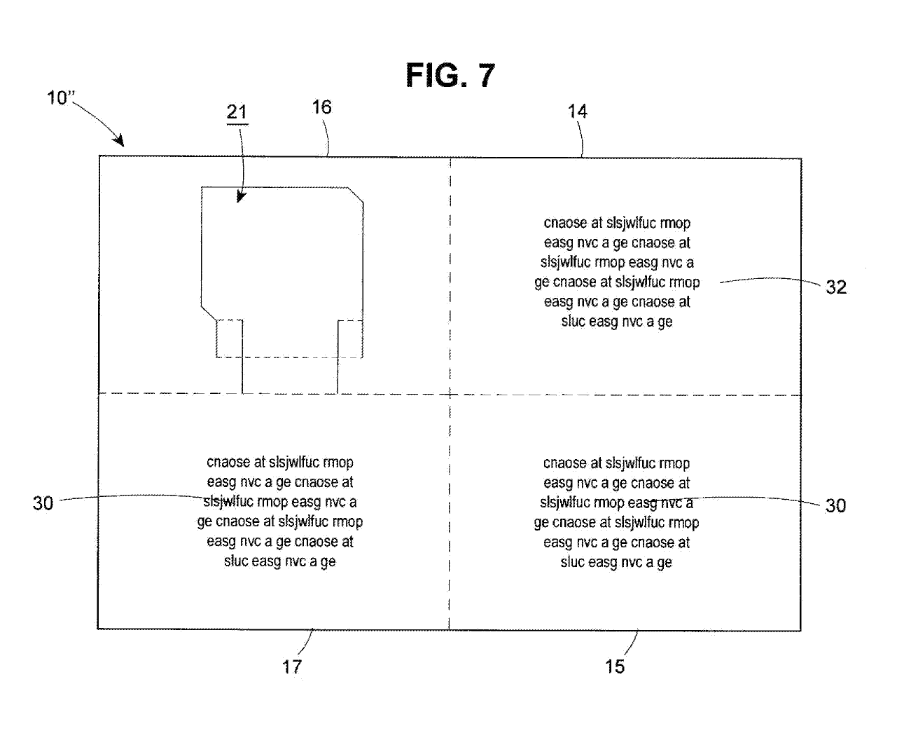

FIG. 7 illustrates a back view of the blank of FIG. 6.

Referring to FIGS. 1 and 3, the blank 10 for making a Pop-Up greeting card 11 is comprised of a flat sheet of card stock having a pair of mutually perpendicular fold lines 12, 13 dividing the sheet into four equal sections 14,15,16,17. The vertical fold line 12, as viewed, may be a simple fold line while the horizontal fold line 13 may be a perforated line of weakening. For example, the fold line 13 may be a perforated line wherein the perforations penetrate only partially into the blank 10 in order to present a smooth surface to the folded top edge of the greeting card 11.

The blank may be made of any suitable size and thickness for use in making a greeting card or similar card. For example, the blank 10 may be 8.5 inches by 11 inches.

Referring to FIG. 2, each section 14, 15, 16, 17 of the blank 10 has a backing of adhesive, for example, composed of a pair of spaced apart adhesive blocks 18, 19 as well as one or more removable liners 20 that cover the adhesive blocks 18, 19 on the blank 10.

Referring to FIG. 1, one section 16 of the blank 10 is die cut to form a pop-up flap 21 that can be hinged out of the section 16 while remaining connected to the blank 10.

The face of the blank 10 is provided with two small adhesive areas 22, 23 on opposite sides of the horizontal fold line 13 with one adhesive area 22 located on a bottom of the pop-up flap 21 and the other adhesive area 23 located on the section 17 of the blank opposite the die-cut section 16. A small removable liner 24 is placed over the two adhesive areas 22, 23.

Referring to FIGS. 1 and 3, the pop-up flap 21 is shaped to have a main section 25 that may contain printing or imaging 26 to convey a message or other pictorial information to a recipient of the greeting card 11 and that can be pulled away from the die-cut section 16 of the card 11 to an outstanding position.

In addition, the pop-up flap 21 has a support section 27 of narrower width than the main section 25 and that extends from the main section 25 to the fold line 13 between the two small adhesive areas 22, 23. This support section 27 has a fold line 28 to facilitate folding of the support section 27 in half when the greeting card 11 is opened.

The pop-up flap 21 also has a pair of hinge sections 29 (only one of which is shown in FIG. 3) disposed on opposite sides of the support section 27, each of which extends from the main section 25 of the flap 21 to the die-cut section 16. Each hinge section 29 serves to support the main section 25 of the flap 21 in an outstanding position from the die-cut section 16, as shown in FIG. 3, when the card is opened.

As indicated in FIG. 1, a die-cut line 30 in the section 16 forms the outline of the flap 21.

In order to form the pop-up greeting card 11, the liners 20 on the back of the blank 10 are removed to expose the adhesive 18, 19 underneath and the blank 10 is folded in half along one of the vertical fold line 12 so that the overlying sections of the blank may be adhesively secured together into a two-ply structure.

Next, the small liner 24 on the face of the blank 10 is removed to expose the adhesive areas 22, 23 underneath and the two-ply structure folded along the horizontal fold line 13 to bring the two adhesive areas 22, 23 into contact and to form the greeting card 11. Pressing of the two adhesive areas 22, 23 together forms a firm bond therebetween.

Next, the card 11 is opened so that the pop-up flap 21 is pulled out of the die-cut section 16 as indicated in FIG. 3. In this position, the support section 27 of the flap 21 is folded over on itself about the fold line 28 since the lower half of the support section 27 is adhesively secured to the lower section 17 of the blank 10. Thus, as the greeting card 11 is being opened, e. g. by pivoting of the front of the card 11 relative to the back of the card 11, the main section 25 and the upper half of the support section 27 of the flap 21 pivots about the fold line 28 of the support section 27 while popping out of the die-cut section 16.

As indicated in FIGS. 1 and 3, the hinge sections 29 are of the same length as the upper half of the support section 27 so as to hold the main portion 25 of the flap 21 parallel to the die-cut section 16 when the card 11 is opened.

As indicated in FIG. 1, the blank 10 may be provided with imaging 30 on each of the four sections 14, 15, 16, 17.

Referring to FIG. 3, the greeting card 11 formed by the blank 10 is comprised of a pair of sections 16, 17 disposed on opposite sides of the fold line 13 therebetween with the upper section 16, as viewed, having the die-cut area forming the pop-up flap 21. The adhesive means formed by the two adhesive areas 22, 23 (not shown) secures a first portion of the support section 27 to the lower section 17 whereby upon pivoting of these two sections 16, 17 from each other in response to opening of the card 11, the pop-up flap 21 and the support section 27 are pulled out of the upper section 16 to position the main portion 25 in spaced parallel relation to the upper section 16.

As illustrated, the main portion 25 of the pop-up flap 21 has imaging 26 thereon to convey information to a recipient.

Referring to FIG. 4, wherein like reference characters indicate like parts as above, each of the small adhesive areas 22, 23 for the flap 21 may be formed by a cohesive.

Referring to FIG. 5, wherein like reference characters indicate like parts as above, the back of each section 14, 15, 16, 17 of the blank 10′ may be formed with interrupted lines of adhesive 31. In addition, imaging 32 may be placed on the back of the blank section 14 for viewing through the window created by the separation of the flap 21 from the die-cut section 16.

Referring to FIG. 3, where the card 1 is formed from the blank 10′ of FIGS. 4 and 5, each of the sections 16, 17 of the card 11 is of two-ply construction and the die-cut area is formed in one ply of the upper section 16. The second ply of this upper section 16 has imaging 32 thereon for viewing through a window formed upon removal of the main portion 25 of the pop-up flap 21 from the ply of the upper section 16.

Referring to FIG. 6, wherein like reference characters indicate like parts as above, each of the small adhesive areas 22, 23 for the flap 21 may be formed by a cohesive.

Referring to FIG. 7, wherein like reference characters indicate like parts as above, imaging 32 may be placed on the back of the blank section 14 for viewing through the window created by the separation of the flap 21 from the die-cut section 16.

As indicated in FIG. 7, the back of the blank 10″ need not have any adhesive thereon. In this case, the greeting card that is formed from the blank 10″ may be fully opened by a recipient. In addition, the backs of each of the sections 14, 15, 16,17 of the blank 10″ may be provided with imaging 30.

The pop-up greeting card may also be made of three sections that fold in a Z-manner. In this respect, the greeting card may be made in a similar manner to the embodiment of FIG. 1. That is, the card is made of the two sections 16, 17 with the pop-up flap 21 plus a third section (not shown) that extends downwardly, as viewed, from the section 17 about a fold line.

What is claimed is:

1. A blank for making a greeting card comprising
a flat sheet of card stock having a pair of mutually perpendicular fold lines dividing said sheet into four equal sections;
one of said sections having a die-cut area for forming a pop-up flap having a main section for imaging of a message thereon, a support section of narrower width than said main section extending from said main section to a respective one of said pair of fold lines and a pair of hinge sections disposed on opposite sides of said support section, each said hinge section extending from said main section to said one section;
a first adhesive area on said support section, and
a second adhesive area on a second section of said four equal sections opposite said first adhesive area relative to a fold line therebetween.

2. A blank as set forth in claim 1 further comprising a liner removably disposed over each of said first adhesive area and said second adhesive area.

3. A blank as set forth in claim 1 further comprising an adhesive on a back side of each said section and a liner removably mounted over said adhesive on said back side of each said section.

4. A blank as set forth in claim 1 wherein each said hinge section is of the same length as the upper half of said support section.

5. A blank as set forth in claim 1 wherein said support section has a fold line for folding of said support section in half.

6. A blank as set forth in claim 1 wherein each of said first adhesive area and said second adhesive area has a cohesive thereon.

7. A blank as set forth in claim 1 wherein said adhesive on said back side of each said section is in the form of interrupted lines of adhesive.

8. A blank as set forth in claim 7 wherein a third section of said sections has imaging thereon for folding over said main portion of said pop-up flap.

9. A greeting card comprising
a pair of sections disposed on opposite sides of a fold line therebetween,
one of said sections having a die-cut area forming a pop-up flap having a main section, a support section of narrower width than said main section extending from said main section to said fold line and having a fold line for folding of said support section into a first portion and a second portion, and a pair of hinge sections disposed on opposite sides of said support section, each said hinge section extending from said main section to said one section;
adhesive means securing said first portion of said support section to the other of said sections whereby upon pivoting of said sections from each other in response to opening of the card said pop-up flap and said support section are pulled out of said one section to position said main portion in spaced parallel relation to said one section.

10. A greeting card as set forth in claim 9 wherein said main portion has imaging thereon to convey information to a recipient.

11. A greeting card as set forth in claim 9 wherein each of said pair of sections is of two-ply construction and said die-cut area is formed in one ply of said one section.

12. A greeting card as set forth in claim 11 wherein a second ply of said one section has imaging thereon for viewing through a window formed upon removal of said main portion of said pop-up flap from said one ply of said one section.

13. A greeting card as set forth in claim 11 wherein each ply of a second of said pair of sections has imaging thereon.

14. A greeting card as set forth in claim 11 wherein each ply of each of said pair of sections is adhesively secured to each other.

15. A greeting card as set forth in claim 9 wherein a third section extends from one of said pair of sections whereby said pair of sections and said third section are foldable in a Z-manner.
